(19) United States
(12) Patent Application Publication
(10) Pub. No.: US 2012/0303473 A1
(43) Pub. Date: Nov. 29, 2012

(54) METHOD FOR TRADING AND TRIAL RUNNING INTEGRATED CIRCUIT DESIGN CODE

(76) Inventors: CHIA-FEN HUANG, Hsinchu County (TW); Yu-Ju Yeh, Taichung City (TW); Chiao-Leng Wang, Hsinchu County (TW)

(21) Appl. No.: 13/480,824

(22) Filed: May 25, 2012

(30) Foreign Application Priority Data
May 26, 2011 (TW) 100118428

(51) Int. Cl. G06Q 30/06

(52) U.S. Cl. 705/26.1

(57) ABSTRACT

A method for trading and trial running an integrated circuit design code is provided. In the method, the integrated circuit design code is converted to a netlist, which is then trial ran and traded between a buyer and a seller on a network platform. The buyer raises a procurement request for an integrated circuit design code on the network platform, and the seller synthesizes the integrated circuit design code to the netlist and completes a trade with the buyer on the network platform. Alternatively, the buyer raises a trial run request for the netlist described by the seller on the network platform, and the seller encrypts the netlist to an encrypted netlist for the trial sampling of the buyer. Accordingly, a trade for the integrated circuit design code is achieved via the network platform for promoting cloud computing, competitiveness and affordability of the industry.

### FIELD OF THE INVENTION

The present invention relates to an integrated circuit design code, and particularly to a method for trading and trial running an integrated circuit design code.

### BACKGROUND OF THE INVENTION

Accompanied with the ever-progressing technology, transistors utilized in an integrated circuit have significantly miniaturized. As a result, on a printed circuit board of a same area compared to earlier days, a density of transistors disposed on an integrated circuit becomes larger and larger, and wirings get more and more complicated, such that a design of an integrated circuit is faced with greater challenges than ever before. In response, Silicon Intellectual Property (SIP) is developed. The SIP is a predefined, verified and reusable function block. For example, current central processing chips or display chips are all consist of many designs of integrated circuits. Functions of the chips are provided by different circuit modules in the chips. Each of the circuit modules, being defined as an element having a specific function, is so-called the SIP.

The industry of integrated circuits is encouraged by the development of SIP. For example, with reference to “System and Method for IP-Based LSI Design” of Taiwan Patent Publication No. 542978 and “System and Method for Performing Intellectual Property Merge” of U.S. Pat. No. 7,096,439, a close relationship between the developments of SIP and integrated circuits is observed. A key for developing the SIP is established on engineers who build the SIP by utilizing integrate circuits. In an integrated circuit design house, based on personal intellects including knowledge, skills and experiences, engineers compose integrated circuit design codes supporting different functions for further constructing into SIPs of different functions. In other words, the integrated circuit design codes are painstaking results based on intellects of the engineers, and are considered as a most valuable asset for the integrated circuit design house. However, purposes and essence of a well-composed integrated circuit design code can be easily appreciated by another engineer of a familiar field. Thus, this engineer can readily modify the integrated circuit design code into another integrated circuit design code that has an equivalent function but yet written in a different way, such that it is difficult for the original engineer to prove that this other engineer is a plagiarist or an original creator. Therefore, to protect private intellectual properties from possible losses caused by plagiarism, source codes are regarded as top confidential by companies and are not easily exchanged with others.

Accordingly, codes that are made public are easily tampered by associated individuals, and it is often too difficult to prove whether the tampering individual is a plagiarist or an original creator, leaving the industry of integrated circuit design codes to encounter the problems below.

First of all, on top of the lack of a platform for trading integrated circuit design codes, integrated circuit design codes cannot be traded through public auctions and biddings either. Further, the industry of integrated circuit design codes not only has few competitors but is also like be monopolized. Hence, a desired integrated circuit may be ridiculously over-priced due to the lack of a standard price reference, and a buyer is prone to a high risk of the purchased integrated circuit design code being non-refundable as the code is purchased under an agreement.

Secondly, in the integrated circuit design industry, it is apparent that closed-thinking within one single company or of one individual is unlikely to excel collective thinking of engineers of integrated circuit design houses all over the world, inferring that the progress of the industry may be hindered by the current closed-thinking.

In addition, for an integrated circuit design house, to develop one SIP, it is possible that although a company has the capability to write 90% of the codes forming the SIP, the complete SIP cannot be fully constructed as the company is unable to purchase the remaining 10% by customization from the open public.

### SUMMARY OF THE INVENTION

Therefore the primary object of the present invention is to solve the problem that an integrated circuit design code cannot be traded in public on a network.

Another object of the present invention is to provide a channel for raising a request, bidding in public, trial running, and trading an integrated circuit design code for individuals associated with the integrated circuit design code.

To accomplish the above objects, a method for trading a netlist of an integrated circuit design code is provided. The method allows a buyer and a seller to trade the netlist on via a network platform. The method comprises: a synthesis step, in which the seller synthesizes the integrated circuit design code into the netlist; a disclosure step, in which the seller discloses function information associated with the netlist and sets a selling price on the network platform; and a transaction step, in which, after surfing the function information on the network platform, the buyer purchases the netlist from the seller at a selling price agreed by the seller and obtains the netlist from the seller via the network platform.

A method for trial running a netlist of an integrated circuit design code is further provided. The method allows a buyer to trial run the netlist being sold in public by a seller via a network platform. The method comprise: a synthesis step, in which the seller synthesizes the integrated circuit design code into the netlist; a disclosure step, in which the seller discloses function information associated with the netlist and sets a selling price and a first trial run price on the network platform; and a trail run step, in which, after the surfing the function information, the buyer obtains an encrypted netlist formed from encrypting the netlist for trial running from the seller at a second trial run price agreed by the seller via the network platform.

Therefore, the present invention provides a method for trading and trial running an integrated circuit design code. The integrated circuit is synthesized to the netlist, and is accordingly trial ran and traded on the network platform. Since a integrated circuit design code is not easily acquired after synthesizing it to the netlist, the creation of the code is protected for the seller to achieve public auctioning, trading, and bidding. Further, the encrypted netlist may be offered to the buyer for trial running to prevent buying an unsuitable netlist. Moreover, a buyer (e.g., a company) may disclose required program functions, and obtain a required core program at a reasonable price through an open, cloud computed and competitive manner for reducing time to market of an integrated circuit chip, while a seller (e.g., a program writer) may also freelance at home for further promoting the development of the integrated circuit design industry.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram illustrating a relationship between a network platform, a buyer and a seller according to a first embodiment of the present invention.

FIG. 2 is a flowchart according to the first embodiment of the present invention.

FIG. 3 is a schematic diagram illustrating a relationship between a network platform, a buyer and a seller according to a second embodiment of the present invention.

FIG. 4 is a flowchart according to the second embodiment of the present invention.

### DETAILED DESCRIPTION OF THE PREFERRED EMBODIMENTS

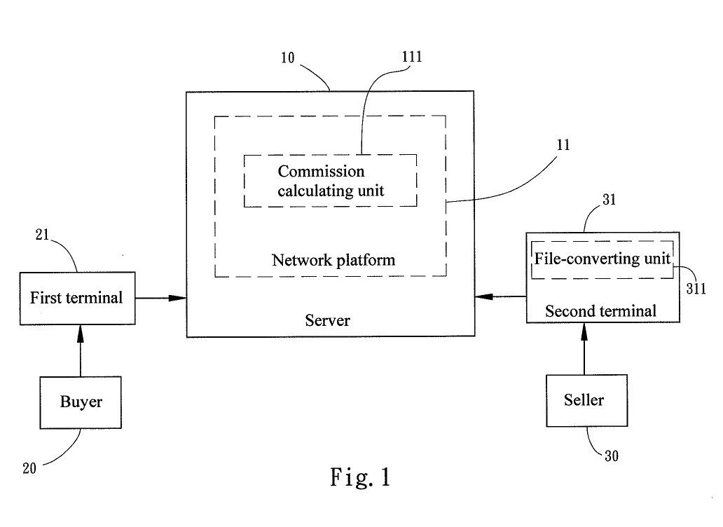

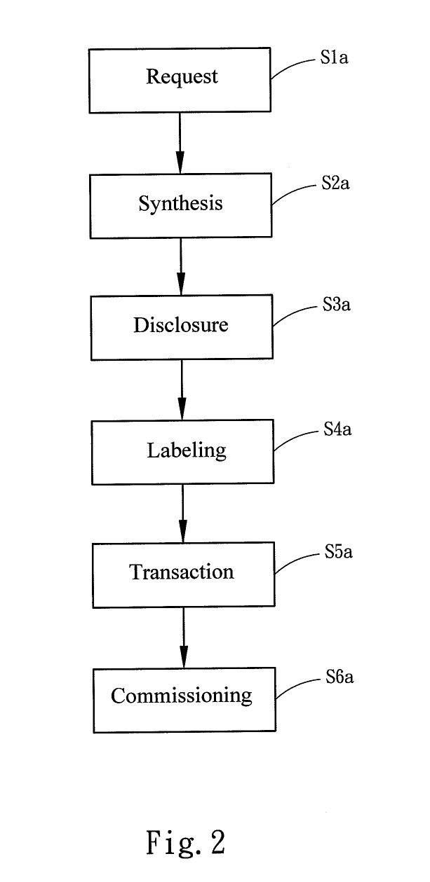

FIG. 1 shows a schematic diagram illustrating a relationship between a network platform, a buyer and a seller according to a first embodiment of the present invention. FIG. 2 shows a flowchart according to the first embodiment of the present invention. Referring to FIGS. 1 and 2, in a method for trading a netlist of an integrated circuit design code, the netlist is traded between a buyer 20 by a first terminal 21 and a seller 30 by a second terminal 31 via a network platform 11 built at a server 10. The integrated circuit design code is a verilog code or a Very High Speed Integrated Circuit Hardware Description Language (VHDL). The second terminal 31 comprises a file-converting unit 311. The network platform 11 comprises a commission calculating unit 111. The method comprises the following steps.

The method begins with a request step S1a. In Step S1a, the buyer 20 connects to the server 10 by use of the first terminal 21, and raises a procurement request for the integrated circuit design code on the network platform 11. The buyer 20 further describes function information of the integrated circuit design code and sets a buying price willing to pay.

In a synthesis step S2a, the seller 30 connects to the server 10 by use of the second terminal 31, and finds the procurement request for the integrated circuit design code disclosed by the buyer 20. According to the function information described by the buyer 20, the seller 30 composes the integrated circuit design code, and synthesizes the integrated circuit design code to the netlist by the file-converting unit 311 of the second terminal 31.

In a disclosure step S3a, the seller 30 discloses function information associated with the netlist on the network platform 11, sets a selling price and publishes a sale message on the network platform 11.

Next, in a labeling step S4a, the seller 30 obtains a sales serial number on the network platform 11, and implants a tag program in the netlist. The tag program records not only the sales serial number, but also associated information of the netlist, e.g., a sales date, an author, a selling price, functions and a name of the network platform 11. The associated information of the netlist helps to better trace an origin in the event of an illegal distribution of the netlist after the netlist is sold.

In a transaction step S5a, the buyer 20 surfs and finds the sales message associated with the needed integrated circuit design code on the network platform 11. After comparing the selling price and selecting the required functions, the buyer 20 decides to proceed to a next level of a transaction. Having negotiated with the seller 30, the buyer 20 purchases the netlist from the seller 30 at a transaction price agreed by the seller 30 via the network platform 11. For example, the transaction price is smaller than or equal to the selling price.

In a commissioning step S6a, after the trading between the buyer 20 and the seller 30 is completed, by utilizing the transaction price as a base, the commission calculating unit 111 of the network platform 11 calculates a commission payable by the buyer 20 or the seller 30 to a manager of the network platform 11. For example, the commission is a predetermined percentage of the transaction price, or a fixed price calculated on the basis of the number of successful transactions. The commission serves as one of revenue sources of the network platform 11.

In an alternative embodiment, in the absence of a request raised in advance by the buyer 20 as based on actual requirements, the seller 30 may directly synthesize the integrated circuit design code to the netlist to be traded, and disclose the function information and the selling price on the network platform 11. After surfing and selecting the function information corresponding to the required netlist, the buyer 20 purchases the netlist from the seller 30 at a transaction price agreed by the seller 30 and obtains the netlist via the network platform 11. Further, when the trading is complete, the manager of the network platform 11 is entitled to the commission from the buyer 20 or the seller 30. For example, the commission is calculated according to the transaction price, or is regulated by the manager.

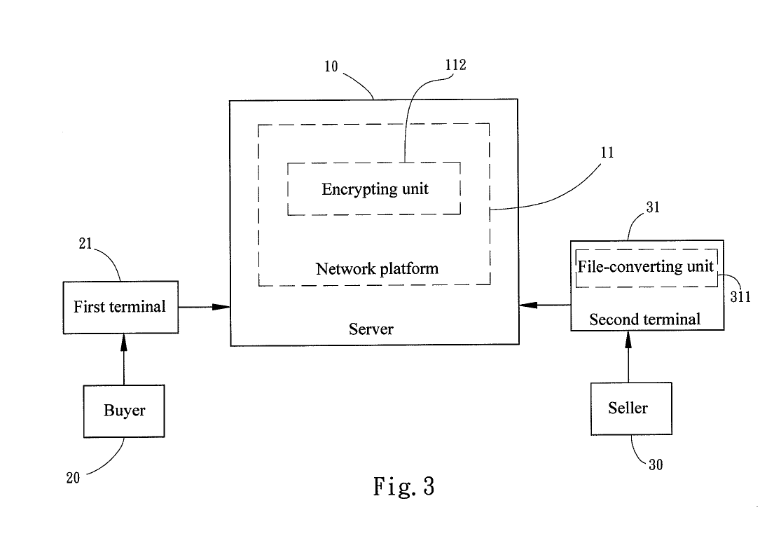

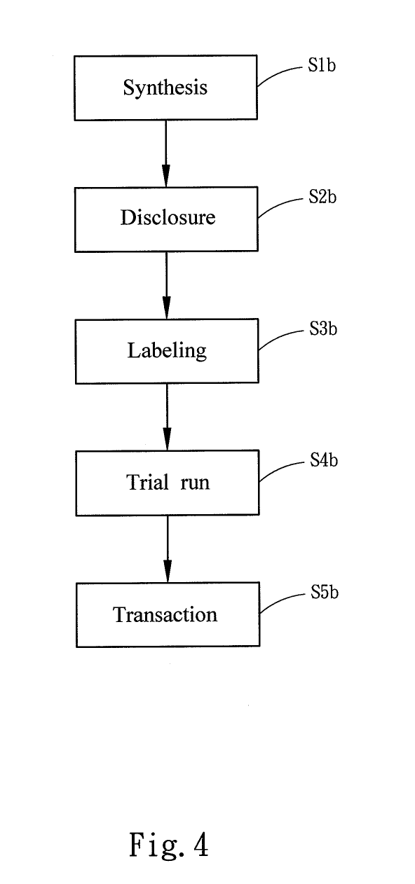

FIG. 3 shows a schematic diagram illustrating a relationship between a network platform, a buyer and a seller according to a second embodiment of the present invention. FIG. 4 shows a flowchart according to the second embodiment of the present invention. In a method for trial running a netlist of an integrated circuit design code according to the second embodiment, the buyer 20 is allowed to trial run the netlist being sold in public by the seller 30 on the network platform 11 via the network platform 11. The buyer 20 and the seller 30 connect to the network platform 11 built at the server 10 by use of the first terminal 21 and the second terminal 31 respectively. The second terminal 31 comprises a file-converting unit 311. The network platform 11 comprises an encrypting unit 112. The method comprises the following steps.

The method begins with a synthesis step S1b. In the synthesis step S1b, by use of the file-converting unit 311 of the second terminal 31, the seller 30 synthesizes the composed integrated circuit design code to the netlist.

In a disclosure step S2b, the seller 30 discloses function information associated with the netlist on the network platform 11, and sets a selling price and a first trial run price on the network platform 11.

Next, in a labeling step S3b, the seller 30 obtains a sales serial number on the network platform 11, and implants a tag program in the netlist. The tag program records not only the sales serial number, but also associated information of the netlist, e.g., a sales date, an author, a selling price, functions and a name of the network platform 11. The associated information of the netlist helps to better trace an origin in the event of an illegal distribution of the netlist after the netlist is sold.

In a trial run step S4b, after surfing the function information on the network platform 11, the buyer 20 raises a trial run request to the seller 30 via the network platform 11, and obtains from the seller 30 an encrypted netlist generated from encrypting the netlist for trial run at a second trial run price agreed by the seller 30 via the network platform 11. In this step, the seller 30 encrypts the netlist by the encrypting unit 112 to generate the encrypted netlist. The encrypted netlist is for the buyer 20 to carry out simulations and tests, and the buyer 20 is incapable of restoring the encrypted netlist back to the original netlist to acquire original content of the netlist. The second trial run price is a price negotiated between the buyer 20 and the seller 30, and is smaller than or equal to the first trial sample price, for example. In this step, the seller 30 may also use an encryption program to encrypt the netlist into an encrypted netlist.

Next, in a transaction step S5b, after trial running the encrypted netlist, the buyer 20 decides to proceed to a next level of a transaction. Having negotiated with the seller 30, the buyer 20 purchases the netlist from the seller 30 at a transaction price agreed by the seller 30 via the network platform 11. For example, the transaction price is smaller than or equal to the selling price. Further, when the trading is complete, the manager of the network platform 11 is entitled to the commission from the buyer 20 or the seller 30. For example, the commission is calculated according to the transaction price, or is regulated by the manager.

In an alternative embodiment, based on actual requirements, the buyer 20 raises in advance a procurement request associated with the integrated circuit design code on the network platform 11. The procurement request includes function information and an expected buying price. After surfing the procurement request, the seller 30 synthesizes the integrated circuit design code matching the procurement request to the netlist, and discloses the function information, the selling prices and the first trial sample price on the network platform 11. When the buyer 20 surfs and selects the function information corresponding to the required netlist, the buyer 20 purchases the encrypted netlist generated from encrypting the netlist for trial running from the seller 30 at a transaction price agreed by the seller 30 via the network platform 11.

Therefore, the present invention provides a method for trading and trial running an integrated circuit design code. The integrated circuit is synthesized to the netlist, and is accordingly trial ran and traded on the network platform. Since a integrated circuit design code is not easily acquired after synthesizing it to the netlist, the creation of the code is protected for the seller to achieve public auctioning, trading and bidding. Further, the encrypted netlist may be offered to the buyer for trial running to prevent buying an unsuitable netlist. Moreover, a buyer (e.g., a company) may disclose required program functions, and obtain a required core program at a reasonable price through an open, cloud computed and competitive manner for reducing time to market of an integrated circuit chip. Meanwhile, different sellers (e.g., program writers from worldwide) can be gathered to compose required programs to achieve collective thinking that by far excels the closed-thinking of one single company or an individual designer, and a seller can freelance at home, so as to further promote cloud computing and integrated circuit design industry.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for trading a netlist of an integrated circuit design code, for providing a buyer and a seller to trade the netlist via a network platform, the method comprising:
a synthesis step, the seller synthesizing the integrated circuit design code to the netlist;
a disclosure step, the seller disclosing function information associated with the netlist and setting a selling price on the network platform; and
a transaction step, after surfing the function information on the network platform, the buyer purchasing the netlist at a transaction price agreed by the seller and obtaining the netlist via the network platform.

2. The method of claim 1, the network platform comprising a commission calculating unit, after the transaction step, the method further comprising:
a commissioning step, the commission calculating unit calculating a commission payable to a manager of the network platform.

3. The method of claim 2, wherein the commission calculating unit calculates the commission by utilizing the transaction price as a base.

4. The method of claim 1, wherein the selling price is equal to the transaction price.

5. The method of claim 1, wherein the integrated circuit design code is selected from the group consisting of a verilog and a Very High Speed Integrated Circuit Hardware Description Language (VHDL).

6. The method of claim 1, between the disclosure step and the transaction step, further comprising:
a labeling step, the seller obtaining a sales serial number on the network platform and implanting the sales serial number in the netlist.

7. The method of claim 1, before the synthesis step, further comprising:
a request step, the buyer raising a procurement request for the integrated circuit design code on the network platform.

8. A method for trial running a netlist of an integrated circuit design code, for a buyer to trial run the netlist being sold in public by a seller via a network platform, the method comprising:
a synthesis step, the seller synthesizing the integrated circuit design code to the netlist;
a disclosure step, the seller disclosing function information associated with the netlist and setting a selling price and a first trial run price on the network platform; and
a trial run step, after surfing the function information on the network platform, the buyer obtaining at a second trial run price agreed by the seller an encrypted netlist generated from encrypting the netlist from the seller via the network platform.

9. The method of claim 8, wherein the network platform comprises an encrypting unit, and the seller encrypts the netlist by the encrypting unit to generate the encrypted netlist.

10. The method of claim 8, wherein the encrypted netlist is for simulations and tests of the buyer.

11. The method of claim 8, wherein the first trial run price is calculated or set according to the selling price.

12. The method of claim 8, wherein the first trial run price is equal to the second trial run price.

13. The method of claim 8, wherein the integrated circuit design code is selected from the group consisting of a verilog and a VHDL.

14. The method of claim 8, between the disclosure step and the trial run step, further comprising:
a labeling step, the seller obtaining a sales serial number on the network platform and implanting the sales serial number in the netlist.

15. The method of claim 8, after the trial run step, further comprising:
a transaction step, the buyer purchasing the netlist at a transaction price agreed by the seller and obtaining the netlist via the network platform.

16. The method of claim 15, wherein the selling price is equal to the transaction price.
